(19) United States
(12) Patent Application Publication
(10) Pub. No.: US 2024/0304030 A1
(43) Pub. Date: Sep. 12, 2024

(54) VIRTUAL DJ SYSTEM

(71) Applicant: Raja Singh Tuli, Montreal (CA)

(72) Inventor: Raja Singh Tuli, Montreal (CA)

(21) Appl. No.: 18/596,433

(22) Filed: Mar. 5, 2024

Related U.S. Application Data
(60) Provisional application No. 63/450,218, filed on Mar. 6, 2023.
(60) Provisional application No. 63/525,016, filed on Jul. 5, 2023.

(51) Int. Cl. G06V 40/20

(52) U.S. Cl. CPC G06V 40/20

(57) ABSTRACT

The present invention relates to a virtual DJ system that utilizes one or more cameras and an Infrared sensors to measure the audience's heartbeat rate, breathing rate and body temperature in order to determine audience engagement levels. The system utilizes a processing unit to analyze the sensor data from the cameras and infrared sensor. The processing unit can further select and play media content based on the determined audience engagement levels. The virtual DJ system determines an initial playlist based on the time of day. The virtual DJ system updates the initial playlist based on one or more of changes in the audience's heartbeat rate at the start of the media content or any significant beat change in the media content, characteristic movement patterns of the audience and/or the engagement level of the audience with the media content being played.

### CROSS-REFERENCE TO RELATED APPLICATIONS

This application claims priority to U.S. provisional patent application No. 63/450,218, entitled “VIRTUAL DJ SYSTEM,” filed on Mar. 6, 2023, and to U.S. provisional patent application No. 63/525,016, entitled “VIRTUAL DJ SYSTEM,” filed on Jul. 5, 2023. The contents of these U.S. provisional patent applications are hereby incorporated by reference in its entirety for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure generally relates to a DJ system and a corresponding method of selecting and playing media content during an event at a venue such as a restaurant, bar, festival, presentation, or social gathering. More particularly, a method and a system for monitoring and analyzing crowd reactions to particular media content and generating a modified playlist of media content in response to user reactions in the crowd. Embodiments are particularly relevant to the choice of media content played at an event.

### Description of Related Art

Music is a fundamental aspect of culture and daily life. It can be found in a variety of forms and settings, including on the radio, through streaming services, and in cars, elevators, and gyms. One of the most popular forms of media content entertainment is through Disc Jockeys, or DJ's. These individuals are responsible for selecting the media content that is played at public gatherings and private events, such as parties, festivals, and restaurants. The role of the DJ is crucial in determining the success of an event. Not all parties or events have the luxury of hiring a famous DJ, and in some cases, it may be more practical or desirable to use an electronic DJ instead. Electronic DJs, also known as virtual DJs, can be programmed to play specific genres of media content or to cater to a particular audience, and they can also be controlled remotely.

Such a method was presented in U.S. Pat. No. 6,888,457, which discloses a portable apparatus for monitoring the reaction of a user to a performance. The device includes sensors that detect indirect audience responses, such as body movement or sound level, and a user interface that allows audience members to provide direct feedback. The device's processor then combines the indirect and direct responses to create a “user reaction signal” which can be transmitted to a remote device.

Another system for determining audience engagement with music is described in U.S. patent application Ser. No. 20/220,291743 (A1). This system uses a time-based relationship between audience reactions to the media content, such as head-bobbing, and the media content being played by the audio system to determine interest in the media content. This is done by collecting sensor data corresponding to the audio and body movement in a physical environment, and identifying a relationship between the audio and body movement. Based on this relationship, interest in the audio content can be determined. Various actions can then be taken proactively based on this information. However, these systems require sensors worn by the audience members and it may not be practical or feasible for event organizers to collect data from user's wearable devices to determine their engagement with the media content.

It is therefore an object of the present invention to create a virtual DJ system that can detect audience engagement with the current media content through non-verbal cues such as head movement (e.g. head bobbing), lip motion, body language, foot movement, hand gestures, etc., using high-definition cameras. Additionally, this system utilizes an infrared camera to measure audience members' heart rate and body temperature.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to a virtual DJ system and a corresponding method of selecting and playing media, audio, visual, audio-visual, or multimedia content during an event at a venue such as restaurant, bar, festival, or social or professional gatherings such as sales presentations, conferences, meetings, etc. More particularly, a method and a system for monitoring and analyzing crowd reactions to particular media and generating a modified playlist of media content in response to user reactions in the crowd.

According to one or more embodiments of the present invention, a virtual DJ system that utilizes one or more high-definition cameras to detect audience engagement with the media content currently being played at a venue through non-verbal cues such as head movement (e.g. head bobbing), lip motion, body language, foot movement, hand gestures, etc. The virtual DJ system can also utilize one or more infrared cameras to measure audience's physiological characteristics such as heartbeat rate, breathing rate and body temperature. The virtual DJ system determines the engagement of the individuals in the audience based on changes in physiological characteristics such as heartbeat rate, breathing rate, body temperature etc. during a period of time such as beginning of the media content or any significant beat change in the media content being played. A control unit at virtual DJ system determines the reactions of the people in the audience from the images captured by one or more camera systems focused on the people in the audience. An image processing algorithm stabilizes images for each member of the audience separately such that the control unit can identify characteristic movement patterns of each member of the audience individually. In some embodiments of the invention, the characteristic movement patterns can be sitting, standing, dancing, bobbing etc. One or more infrared cameras capture the infrared signatures of the individual people in the audience. An infrared camera can determine the heart rate of an individual as well as changes in the rate of the heartbeat by analyzing changes in the infrared signature of the individual. Furthermore, the temperature and breathing rate of the individual can also be determined. The control unit can determine the level of engagement of the individual with the media content being played based on the identified characteristic movement patterns, rate of change of heartbeat, temperature and breathing rate of the individual. The control unit can select and play media content based on the determined engagement level of the audience.

According to one or more embodiments of the present invention, the virtual DJ system can be used in a restaurant setting where the audience changes depending on the time of day. To adapt to this dynamic environment, the virtual DJ system can create different playlists for different times of the day. Additionally, the virtual DJ system can learn from historical data of the media content/playlist being played at various times of the day and determine the preferences of the audience at a specific time. The initial playlist is determined by the virtual DJ system based on the time of day, and can be updated based on changes in the audience's heartbeat rate at the start of the media content or any significant beat change in the media content, characteristic movement patterns of the audience and/or the engagement level of the audience with the media content being played. Furthermore, the virtual DJ system can determine the next media file to be played based on the engagement level of the audience with the media content being played over a period of time (e.g. the last hour), this allows the system to adapt to the audience's changing preferences in real-time.

According to one or more embodiments of the present invention, the virtual DJ system can comprise at least two camera systems which are strategically placed to capture image data of the audience. The two camera systems have separate field of views with an overlap region. Both camera systems can determine the location and pointing direction of each other by utilizing any suitable method. By using any suitable method of demarking the observed scene, the camera systems can accurately count the individuals in the audience and provide an accurate measurement of audience engagement levels.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective front view of an example virtual DJ System in a restaurant setting in accordance with the various embodiments.

FIG. 2 is a flow diagram illustrating the operation of the virtual DJ system in accordance with the various embodiments.

### DETAILED DESCRIPTION

The subject disclosure is directed to a virtual DJ system and a corresponding method of selecting and playing media, audio, visual, audio-visual, or multimedia content during an event at a venue such as restaurant, bar, festival, or social or professional gatherings such as sales presentations, conferences, meetings, etc. In some examples, the media content can be live media content. More particularly, a method and a system for monitoring and analyzing crowd reactions to particular media and generating a modified playlist of media content, modifying the media content for the future, or modifying the live media while being presented in response to user reactions in the crowd.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

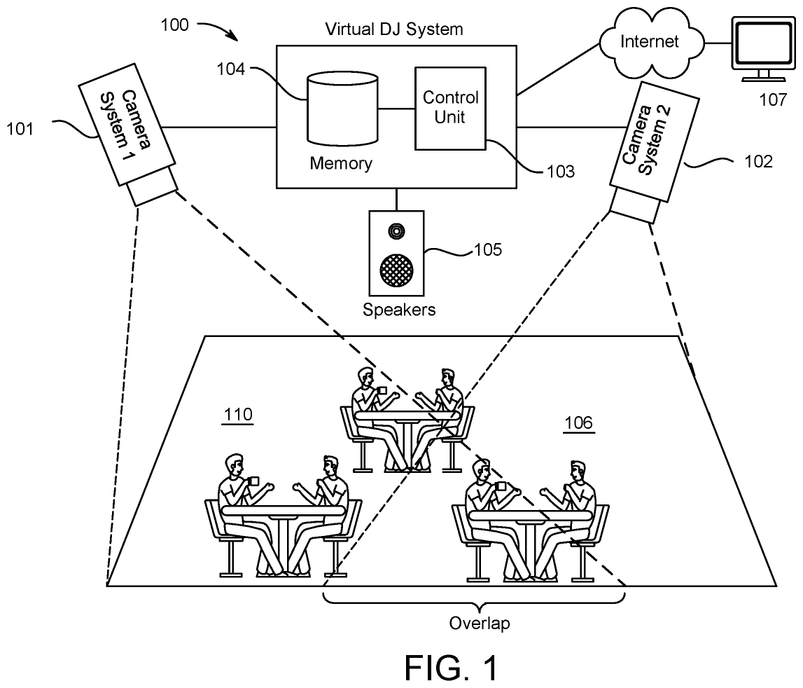

Now referring to the drawings and particularly to FIG. 1, various features of the subject disclosure are now described in more detail with respect to a virtual DJ system, hereby designated as 100. The virtual DJ system 100 can be installed in example environments such as restaurants, bars, pubs, social gatherings etc. The virtual DJ system 100 automatically selects the media content to be played via audio/visual output device (e.g. speakers) 105 based on the monitored reaction of the individuals of the audience. One or more camera systems 101 and 102 are adapted to capture digital images of at least a portion of a monitored environment 110. One or more camera systems 101 and 102 can be provided with an image processor adapted to process digital images to identify the number of people present in the captured images and/or the behaviour of those people. In a preferred embodiment of the invention, one or more camera systems 101 and 102 monitor the reaction of the people to the media content being played in the said environment. In a preferred embodiment of the invention, one or more camera system 101 and 102 may include one or more high-definition RGB cameras, thermal imaging cameras, infrared cameras, laser imaging cameras, monochrome cameras, depth cameras, event-based cameras, and/or any suitable combinations thereof. In some embodiments of the invention, one or more camera systems 101 and 102 may further include illumination sources that emit light, such as a flash. In a preferred embodiment of the invention, one or more camera systems 101 and 102 collect sensor data such as video image data, infrared sensor data etc. of the monitored environment and transmit the sensor data to a control unit 103 of the virtual DJ system 100. A control unit 103 of the virtual DJ system 100 processes the video/image data using any suitable image processing algorithms known in the art. In some embodiments of the invention, one or more camera systems 101 and 102 may include an on-camera image signal processor (ISP) configured to execute a plurality of processing operations on the image data.

The control unit 103 determines the reactions of the people in the audience from the images captured by one or more camera systems 101 and 102. In a preferred embodiment of the invention, one or more camera systems 101 and 102 focus on the faces of the people in the audience. The image processing algorithm implemented on the virtual DJ system 100 stabilizes images for each member of the audience separately such that the control unit 103 can identify characteristic movement patterns of each member of the audience 106 individually. In some embodiments of the invention, the characteristic movement patterns can be sitting, standing, dancing, bobbing etc. One or more infrared cameras capture the infrared signatures of the individuals in the audience. By analyzing changes in the infrared signature of an individual, the infrared camera can determine the heart rate of the person as well as changes in the rate of the heartbeat of the person. Further, the temperature and breathing rate of the individual can also be determined based on the readings of the infrared camera. Based on the identified characteristic movement patterns, rate of change of heartbeat, temperature and breathing rate of an individual, the control unit 103 determines the engagement level of the individual with the media content being played. In some embodiments of the invention, the control unit 103 selects media content from a memory storage device 104 provided on the virtual DJ system 100. The selected media content can be played by one or more speakers 105. In another embodiment of the invention, the control unit 103 can download media content from a server 107 (e.g. a local server, a remote server, a cloud server etc.). In some embodiments, the server 107 enables the virtual DJ system 100 to access a larger selection of media content to better fulfill media content wishes of the audience from various media content services including but not limited to, Spotify, Prime Music, Apple Music etc.

In an alternate embodiment of the invention, the control unit 103 can be provided on one or more camera systems 101 and/or 102. The camera systems 101 and 102 can process the captured video images and determine audience engagement. In some embodiments of the invention, the camera systems 101 and 102 can provide instructions to the control unit 103 to select the media content to be played by the speakers. In various embodiments of the invention, the control unit 103 includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. The one or more cameras 101 and 102 and speakers are connected to virtual DJ system 100 using any suitable communication medium wired or wireless.

In some embodiments of the invention, the virtual DJ system 100 may also determine the presence, absence or count of people in the monitored environment using the camera systems 101 and 102. In some embodiments of the invention, the control unit 103 can recognize characteristic behavior patterns of one or more individuals of the audience 106. Such characteristic behavior patterns can comprise behavior patterns that are characteristic for enthusiasm, exhaustion, or boredom, etc. Identifying such characteristic behavior patterns allows the virtual DJ system 100 to better adapt the media content. For example, if the control unit 103 recognizes that many members of the audience are enjoying the media content, the control unit 103 can select media content with similar energy.

In some embodiments of the present invention, the virtual DJ system can use an Artificial Intelligence algorithm to determine the engagement level of individual members of the audience. In one embodiment, the virtual DJ system uses an AI algorithm trained on a large set of data to recognize and quantify engagement level based on identified movement, behavior, head and facial patterns. The trained algorithm may identify movement, behavior, head and facial patterns from images captured by the camera systems 101 and 102. The trained AI algorithm may recognize and correlate movement, behavior, head and facial patterns with significant events or changes in media playback such as beginning of a media content, change in tempo or rhythm of the media content etc. The Al algorithm may measure the engagement of individual members of the audience and determine the number or proportion of people engaged or positively engaged with the media content being played.

In additional embodiments, the virtual DJ system 100 uses one or more Infrared cameras to remotely identify physiological characteristics of the members of the audience. In one embodiment, one or more IR cameras can be used to measure heart rate, temperature, breathing rate etc. of individual members of the audience. The virtual DJ system 100 may use an AI algorithm trained on a large dataset to determine the physiological characteristics of individuals. For example, one or more IR cameras may capture images of a person's face or body and algorithm, such as an AI algorithm, may stabilize the measurements and determine changes in the person's body or facial temperature. The algorithm may further filter the measurements (such as between 40 beats per minute to 200 beats per minute) to determine the heart rate of the person. In another embodiment, the algorithm may use image processing methods to amplify minute changes in temperature measured by detecting changes in facial skin blood flow and determine heart rate of the person by using the amplified temperature signal. The algorithm may determine the person's engagement with the media content being played by correlating changes in the person's physiological characteristics (such as heart rate, temperature of breathing rate etc.) with significant events or changes in media playback such as beginning of a media content, change in tempo or rhythm of the media content etc. The algorithm may measure the engagement of individual members of the audience and determine the number or proportion of people engaged or positively engaged with the media content being played.

In a preferred embodiment of the invention, the engagement level of the audience can be compared with a configurable threshold to determine the next media file (such as song, music piece etc.) or media content to be played by the virtual DJ system 100. In an example embodiment, if the engagement level of the audience with currently playing media content is determined to be equal to or higher than the configurable threshold, the virtual DJ system can select the next song from the playlist to be played or select a song with similar characteristics to the currently playing media content (for example, similar energy, tempo, rhythm, artist, genre etc.). On the other hand, if the engagement level is below the configurable threshold, the virtual DJ system can select a dissimilar song or media content to be played next.

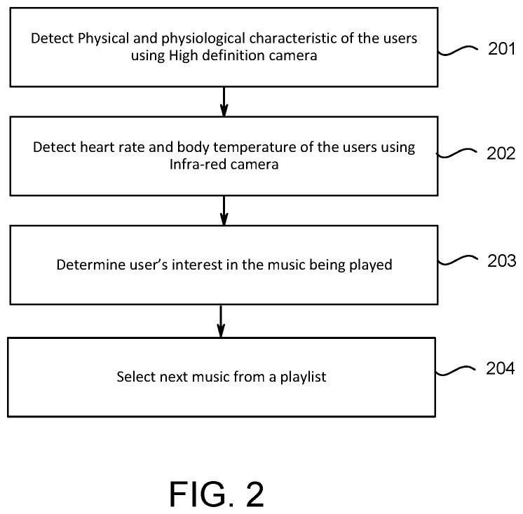

FIG. 2 is a flowchart illustrating a method 200 for identifying the engagement of the individuals with media content being played and creating a playlist based on user engagement detection in accordance with some implementations. In some implementations, a virtual DJ system 100 performs method 200. In some implementations, method 200 is performed on a mobile device, desktop, laptop, head-mounted display or a server. The method 200 is performed by processing logic, including hardware, firmware, software, or a combination thereof. In some implementations, the method 200 is performed on a processor executing code stored in a non-transitory computer-readable medium (e.g., a memory).

At block 201, the method 200 collects physical and physiological data of the members of the audience from one or more camera systems 101 and 102. In some embodiments of the invention, physical and physiological data includes but is not limited to head movement data, lip motion data, body language data, feet movement data, hand movement data or gesture data etc. The image processing algorithm implemented on the virtual DJ system 100 stabilizes images for each member of the audience separately such that the control unit 103 can identify characteristic movement patterns of each member of the audience 106 individually. In some embodiments of the invention, the characteristic movement patterns can be sitting, standing, dancing, bobbing etc.

At block 202, the method 200 collects heartbeat and temperature data of the individuals in the audience from the Infrared camera of one or more camera systems 101 and 102. The method 200 further determines the rate of change in the heartbeat of the individuals upon starting of a particular media content and/or upon any significant change in the beats of the current media content. In some embodiments of the invention, the temperature and breathing rate of the individual can also be determined.

At block 203, the method 200 determines the interest of the individuals in the media content being played based on the characteristic movement patterns, a change of the rate of heartbeat, change of the breathing rate and/or temperature during a particular period of time. In some embodiments of the invention, the interest of a person in particular media content can be determined based on the person's head, hand or feet movement matching the beat of the song or media content. In some embodiments of the invention, the interest of the person in particular media content can be determined based on lip movement while the person is singing along or following the media content. In some embodiments of the invention, the interest of the person in particular media content can be determined based on an identified facial expression, e.g., an expression of focus combined with beat-matched head movement.

In one embodiment of the invention, the control unit 103 or the virtual DJ system may use an artificial intelligence (AI) algorithm for determining the level of engagement of the audience or the individuals in the audience. In some embodiments of the invention, the AI algorithm can be trained to identify the physical and physiological characteristics of the members of the audience. The AI algorithm can determine the audience engagement with a particular media content by processing the captured image data from one or more camera systems 101 and 102.

At block 204, after determining the level of engagement of the audience in the media content started in an event or any significant beat change in the media content currently being played, method 200 determines the next media content to be played from a playlist. In some embodiments of the inventions, a playlist of similar media content can be created based on the identified interest of the audience in the media content.

In another embodiment, the virtual DJ system may create, adapt and/or modify playlists based on particular times of the day. The virtual DJ system may use the measured engagement levels of audiences with media content being played at different times of the day to learn temporal preferences of audiences and adapt the media content playlists based on the learned preferences in addition to real time engagement levels. In an example scenario where the virtual DJ system 100 is used in a restaurant setting, the audience can change depending on the time of day. To adapt to this dynamic environment, the system can create different playlists for different times of the day. Additionally, the virtual DJ system 100 can learn from historical data of the media content/playlist being played at various times of the day and determine the preferences of the audience at a specific time. The initial playlist is determined by the virtual DJ system 100 based on the time of day and can be updated based on audience reactions, changes in the audience's heartbeat rate at the start of the media content or any significant beat change in the media content. Furthermore, the virtual DJ system 100 can determine the next song to be played based on the engagement level of the audience with the media content being played over a period of time (e.g. in the last hour), this allows the system to adapt to the audience's changing preferences in real-time.

In one embodiment of the invention, the virtual DJ system 100 comprises at least two camera systems 101 and 102 which are strategically placed to capture image data of the audience. The first camera system 101 has a first field of view and the second camera system 102 has a second field of view, with an overlap region between the two fields of view as shown in FIG. 1. The first camera system 101 automatically determines the location and pointing direction of the other camera system 102 and vice-versa. Any suitable method including but not limited to a triangulation method using wi-fi signal strength can be utilized for accurately determining the location and pointing direction of each camera. In some embodiments of the invention, the camera systems 101 and 102 can use any suitable method for demarking the observed scene and process the overlap in their fields of view such that the persons present in the overlapping area are counted only once. By demarking the observed scene, the camera systems can accurately count the individuals in the audience. Therefore, virtual DJ system 100 can accurately measure the level of engagement of the audience.

### Heart Rate Variability (HRV)

Heart rate variability (HRV) is generally referred to as the variation in the interval of the heart's electrical signals, i.e. heart beats. HRV can be used as a reliable tool for evaluating various physiological factors that modulate heart rate. Unlike a simple heart rate measurement, HRV provides insights into the balance between the sympathetic and parasympathetic nervous systems. In other words, HRV can be used to measure the fluctuation in time intervals between consecutive heartbeats, reflecting the balance between the sympathetic and parasympathetic nervous systems.

Low Frequency Heart Rate Variability (LF HRV) is a measure of heart rate variability that reflects the influence of the sympathetic nervous system on heart rate. The sympathetic nervous system is responsible for the “fight or flight” response in the body, which is activated in response to physical activity. LF HRV is calculated by analyzing the variability in heart rate at a frequency range of 0.04 to 0.15 Hz, which corresponds to the sympathetic nervous system's influence on heart rate. Higher LF HRV is generally associated with increased sympathetic nervous system activity, while lower LF HRV may indicate decreased sympathetic activity. Generally, LF HRV is used as an indicator of the body's response to some physical activity.

HRV has been used to evaluate the activation of the sympathetic and parasympathetic nervous systems, and it can also be used to determine an individual's likes, dislikes, interests, and engagement towards particular objects, arts, emotions, and more. Incorporating HRV into media content recommendation systems can enhance the personalized nature of the recommendations, improving the overall media content engagement experience. Moreover, the Virtual DJ system can improve the media content recommendations based on HRV data collection and analysis, increasing audience engagement.

In order to use HRV for engagement detection and media content recommendation, various sensors may be used to measure the HRV data of individuals in the audience. In a preferred embodiment of the invention, non-invasive sensors can be used to measure HRV data while the members of the audience are exposed to various types of media content. In alternate embodiments of the invention, HRV data may be collected using wearable devices of the members of the audience. The HRV data can be analyzed to identify patterns in the physiological response of the members of the audience to the played media content. In some embodiments of the invention, a machine learning algorithm may identify the patterns in listeners' physiological responses to the played media content and recommend music aligned with the listeners' interests. In a preferred embodiment of the invention, one or more infrared sensors can be used to collect heart rate data. In some embodiments, IR sensors can also be IR cameras. In alternate embodiments of the invention, thermal imaging cameras, infrared thermography (IRT) devices, or any suitable device capable of measuring the infrared radiations emitted by the skin in low or no visible light conditions, may be used to measure various sensor data including HRV. HRV data can be used to assess psychophysiological variations in response to various stimuli, including music.

In some embodiments of the invention, heart rate variability and heart rate information can be correlated with the sudden movement of the members of the audience at a venue to determine the engagement with the media content being played. While sudden movements in a general audience are typically random, these can still be correlated with specific points in the media content being played. Additionally, the intensity of sudden movement may also change even across the audience. However, if the intensity of sudden movement can be correlated with the beginning of the media content or a specific point in the media content due to a sharp change in the media content being played such as a change in the beat, tempo or melody, that can be used to determine the engagement of the audience. In a preferred embodiment of the invention, sudden movements of the audience above a certain threshold can be correlated with engagement. When this correlation is combined with the media content being played at a venue, it can be used as an indicator of the engagement of the audience in that particular media content. By analyzing the rate of change of each individual's sudden movements and correlating it to the population as a whole, it is possible to identify moments of heightened engagement for the audience. For example, if there is an increase in sharp movements of the number of individuals above a threshold at a particular point in the music, this can be interpreted as a sign of engagement of the audience in the music. In some embodiments, the sharp movements may include actions such as looking towards each other, moving hands, head bobbing, lip movement, feet movement or other sudden movements.

According to another embodiment of the invention, the engagement of the audience in the media content being played at a venue can be increased by the approach followed by traditional human DJs and a playlist can be created based on the determined engagement. Generally, human DJs play non-popular songs before popular ones to build up the excitement of the audience. Similarly, the Virtual DJ system may play non-popular media content in succession at the beginning of an event to build up the excitement of the audience over a period of time. An algorithm implemented in the Virtual DJ system can create a sequence of songs as a playlist to gradually increase audience excitement over time. The algorithm may restart the playlist when a turnover in the audience occurs. In some embodiments of the invention, the algorithm can track the rate of change of the playlist variations and can suggest replaying popular songs. In other embodiments of the invention, the algorithm may restart the playlist if a certain percentage of the audience left the venue and new members join the audience. For example, if a venue has an audience and more than 70% of the audience leave the venue and new members join the audience, the playlist sequence can be restarted to build excitement for the new audience. This way, the excitement can be built up again, and the audience can be engaged with the music. In certain embodiments of the invention, the playlist can also be adjusted based on the demographic of the audience, time of day, or other factors.

According to another embodiment of the invention, the Virtual DJ system can recommend media content based on the mood of the audience at a particular venue. In a preferred embodiment of the invention, heart rate variability data for the members of the audience can be collected using one or more infrared sensors installed at the venue. An algorithm may determine the level of engagement of the audience in the media content being played and recommend new media content accordingly. In addition to HRV data collected using an infrared sensor, the algorithm may also consider the environment setting or venue and specific time of the day to recommend media content that matches the desired mood. For instance, the algorithm can differentiate between a fine dining restaurant and a bar, where the former requires a more calming and content mood while the latter requires a more aggressive and upbeat mood. Additionally, the algorithm can adapt to changes in the audience by continuously monitoring their HRV data and adjusting the music selection accordingly.

According to another embodiment of the invention, the Virtual DJ system can recommend media content based on HRV data collected for the audience and audience recency at a venue. The HRV data can be collected continuously for each member of the audience, and an algorithm may use HRV data to suggest music that is likely to be enjoyed by new members of the audience to keep them engaged for a longer period. The algorithm can consider the amount of time that a member of the audience has spent at a venue to differentiate between old and new audience members. The algorithm may use a weighted average approach to suggest music that is suitable for the audience while taking into account the different amounts of time that each audience member has spent at the venue.

According to another embodiment of the invention, the Virtual DJ system can recommend media content based on recent media content engagement of the audience. The heart rate variability (HRV) data for all the audience at a venue can be collected continuously. The algorithm can determine the media content engagement of the audience in the recent history, typically the last hour or so, and recommends the next media content based on a pre-determined list of media content as well as the media content currently being played. The algorithm takes into account the change in the audience's musical taste and preferences by considering when the population turns over by a certain percentage, for example, 80%. At this point, the algorithm may recommend replaying the entire playlist. The algorithm recommends media content based on the engagement of the audience in the previous and current media contents and HRV data collected using infrared sensor(s). The algorithm also considers the context of the venue and time of day to recommend appropriate music that matches the audience's current mood and setting.

In some embodiments of the present invention, the algorithm may recommend the next media content or generate an entirely new playlist based on the gender composition of the majority of members in the audience. The gender identification process can be facilitated by an AI-based image recognition system integrated into the virtual DJ system. The virtual DJ system may comprise a conventional RGB camera for capturing the visual data of the audience, and the captured images are subsequently processed by AI-based image recognition algorithms to accurately determine the gender of the individual audience members.

By incorporating gender recognition technology, the virtual DJ system can tailor the music recommendations to better suit the preferences and interests of the specific gender majority within the audience. The AI algorithms continuously analyze the gender composition of the audience, allowing for dynamic adjustments to the playlist generation process in real-time. Consequently, the virtual DJ system ensures a more immersive and enjoyable music atmosphere for the audience, resulting in heightened satisfaction and increased participation. It is to be understood that the utilization of AI-based image recognition technology for gender identification is merely one exemplary embodiment, other suitable methods or technologies for gender determination known in the art can be employed within the scope of the present invention. The system can recommend the next media content or create a playlist of the media content based on one or more of the gender compositions of the audience, heart rate variability data detected by the IR sensors, media content engagement of the audience, audience recency at a venue, etc.

According to another embodiment of the invention, the Virtual DJ system can recommend media content to an audience at a venue based on the human body temperature variation. It has been observed that the body temperature of a person can vary depending on their level of engagement or excitement. This variation in body temperature, such as flushness, can be used as an indicator of the audience's level of engagement in the media content being played at a venue. In some embodiments, an infrared camera can be used to record the body temperature of the members of the audience at a venue. The data collected can be analyzed using an algorithm to determine the level of engagement of the audience. Based on the level of engagement, the algorithm can recommend appropriate media content to be played at the venue.

Furthermore, in some embodiments, the method can also collect breathing rate and breathing rate variation data and/or blood pressure data of the members of the audience using infrared sensors. The data collected can be used in conjunction with the body temperature variation data to recommend the media content that is tailored to the audience's level of engagement in the media content. For example, if the audience's breathing rate and blood pressure are elevated, the algorithm can recommend media content with a faster tempo or beat to maintain the engagement level of the audience.

In an alternate embodiment of the invention, the heart rate variability (HRV) data collected through an infrared camera can be used for determining shopping behavior of customers in a store. HRV is a measure of the variation in time between successive heartbeats and is an indicator of the autonomic nervous system's activity. An increase in HRV indicates a higher level of engagement or interest in an activity. One or more infrared cameras can be installed in the store to capture HRV data of the customers. The camera should be positioned in a way that allows it to capture a clear view of the customers' faces. The HRV data is collected in real-time and analyzed to determine the level of engagement or interest of each customer in the products they are engaged with. If the HRV data indicates that the customer is highly engaged, it may suggest that the customer likes the product they are looking at, and the system may recommend similar products or provide additional information to encourage a purchase. In contrast, if the HRV data shows low engagement, it may suggest that the customer is not interested in the product, and the system may suggest alternatives or provide more targeted marketing to the customer. The system may also collect additional data, such as breathing rate and variation or blood pressure data, to further refine the analysis and provide more accurate recommendations. The data collected can also be used to track customer behavior over time, allowing the system to learn and adapt to the customer's preferences and provide more personalized recommendations.

In some embodiments, the customer interest in a particular item within a store can be determined by capturing the customer's gaze using a camera. The gaze of a customer in a store can be captured using a simple RGB camera or any suitable means known in the art capable of capturing the gaze. Simultaneously, heart rate variability (HRV) data can be collected using an infrared (IR) camera at the particular moment or over a specific time period. The collected HRV data can be correlated with the customer's gaze to assess their level of interest in the particular item at the store. Additionally, the duration of time that the customer spends looking at the particular item can be considered as a factor while calculating customer's level of interest in the particular item. By combining the customer's gaze data with HRV data at a particular movement or specific time period, the method can accurately determine and quantify customer interest in items at the store.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

An aspect of the present disclosure provides a method of determining engagement of an audience with media content being played at a venue or event, the method comprising: collecting gesture data of individual members of the audience, wherein the gesture data comprises one or more or head movement data, body movement data and facial expression data; correlating individual gesture data with parts of media content being played; measuring an engagement level of a member of the audience using an Al model trained to measure engagement based on one or more of gesture data, characteristics of media content, time of day information, event information and venue information; determining one or more of an aggregate engagement level of the audience, a number of members of the audience engaged with the media content and proportion of members of the audience engaged with the media content.

According to one mode of this aspect, the part of the media content may be one or more of a beginning of the media content or change in beat, rhythm or tempo of the media content.

According to one mode of this aspect, the gesture data may be determined from images captured by one or more cameras at the venue.

According to one mode of this aspect, the method may include determining areas of overlap in field of views of the one or more cameras and removing duplicate measurements due to the overlapping fields of view.

According to one mode of this aspect, the method may include creating a new media content playlist based on the determined engagement level, number of engaged members of the audience and/or proportion of engaged members of the audience.

According to one mode of this aspect, the method may include updating a media content playlist based on the determined engagement level, number of engaged members of the audience and/or proportion of engaged members of the audience.

Another aspect of the present disclosure provides a method of determining engagement of an audience with media content being played at a venue or event, the method comprising: collecting physiological data of individual members of the audience, wherein the physiological data comprises one or more or heart rate data, breathing rate data and temperature data; correlating individual physiological data with parts of media content being played; and determining one or more of an aggregate engagement level of the audience, a number of members of the audience engaged with the media content and proportion of members of the audience engaged with the media content.

According to one mode of this aspect, the method may include determining changes in physiological data and correlating changes in physiological data with parts of the media content.

According to one mode of this aspect, the part of the media content may be one or more of a beginning of the media content or change in beat, rhythm or tempo of the media content.

According to one mode of this aspect, the physiological data may be determined from images captured by one or more infrared sensors at the venue.

According to one mode of this aspect, the method may include determining areas of overlap in field of views of the one or more infrared sensors and removing duplicate measurements due to the overlapping fields of view.

According to one mode of this aspect, the method may include measuring an engagement level of a member of the audience using an AI model trained to measure engagement based on one or more of physiological data, characteristics of media content, time of day information, event information and venue information.

According to one mode of this aspect, the method may include creating a new media content playlist based on the determined engagement level, number of engaged members of the audience and/or proportion of engaged members of the audience.

According to one mode of this aspect, the method may include updating a media content playlist based on the determined engagement level, number of engaged members of the audience and/or proportion of engaged members of the audience.

Another aspect of the present disclosure provides a method for selecting media content to be played at a venue or event, the method comprising: determining an engagement level of persons present at the event or venue with media content being played at the event or venue; adapting a media content playlist based on the determined engagement level in real time.

According to one mode of this aspect, the engagement level may be an aggregate engagement level for the persons at the event or venue.

According to one mode of this aspect, the engagement level may be an individual engagement level for a person at the event or venue.

According to one mode of this aspect, the engagement level may be determined by correlating parts of media content being played with one or more of gesture data and physiological data of the persons at the venue or event.

According to one mode of this aspect, the gesture data may be determined from images obtained from one or more cameras at the event or venue.

According to one mode of this aspect, the physiological data may be determined from measurements obtained from one or more infrared sensors at the event or venue.

Another aspect of the present disclosure provides a method for determining a person's heart rate, the method comprising: measuring the person's body temperature or breathing rate using one or more infrared sensors, wherein measurements of the one or more infrared sensors are stabilized; determining a change in the person's body temperature or breathing rate; filtering a range of frequencies in the temperature or breathing rate measurements to calculate a heart rate of the person.

According to one mode of this aspect, infrared rays from the one or more infrared sensors may be incident on the person's face or other body parts.

Another aspect of the present disclosure provides a method comprising: presenting media content to members of an audience at a venue; collecting heart rate data of individual members of the audience using one or more infrared sensors at the venue; determining an engagement level of the members of the audience based on the change in the heart rate of the individuals upon occurrence of an event in the media content during playback, wherein the event in the media content includes one or more of the changes in beat, rhythm or tempo of the media content; and changing the live media being presented or media to be played in the future based on the determined engagement level of the individuals.

According to one mode of this aspect, an AI model can be trained to determine the engagement level of the members of the audience based on one or more of heart rate data of the audience, body and facial gesture data of the audience, characteristics of media content, time of day information, event information and venue information.

Another aspect of the present disclosure provides a method comprising: presenting media content to members of an audience at a venue; collecting heart rate data of individual members of the audience using one or more infrared sensors at the venue; determining a variation in heart rate signals of each member of the audience and correlating the variation with parts of the media content, wherein the part of the media content is one or more of a beginning of the media content or change in beat, rhythm or tempo of the media content; calculating heart rate variability (HRV) data for the members of the audience at the venue in correlation of parts of the media content; determining, using the HRV data, the engagement of the audience with the current and/or recently played media content; and changing the live media being presented or media to be played in the future based on the determined engagement level of the audience.

Another aspect of the present disclosure provides a method comprising: presenting media content to members of an audience at a venue; collecting heart rate data of individual members of the audience using one or more infrared sensors at the venue; determining a variation in heart rate signals of each member of the audience and correlating the variation with parts of the media content, wherein the part of the media content is one or more of a beginning of the media content or change in beat, rhythm or tempo of the media content; calculating heart rate variability (HRV) data for the members of the audience at the venue in a correlation of parts of the media content; determining, using the HRV data, the engagement of the audience with the current and/or recently played media content; and preparing a playlist of media content for specific times of the day or specific times of the days of the week based on the determined engagement level of the audience in the media content for each specific time of the day in the week.

Another aspect of the present disclosure provides a method comprising: capturing gaze data of a customer looking at an item in a store using a camera; collecting heart rate variability (HRV) data of the customer using an infrared (IR) camera simultaneously; calculating a time period for the customer looking at the said item; correlating the collected HRV data with the captured gaze data for the time the customer looking at the said item; generating an interest score based on the HRV data, the gaze data, and the time the customer spends looking at the said item; and determining a level of interest of the customer in the said items at the store.

Another aspect of the present disclosure provides a method comprising: presenting stimuli to members of an audience at a venue; collecting heart rate data of individual members of the audience using one or more infrared sensors at the venue; determining a variation in heart rate signals of each member of the audience and correlating the variation with the stimuli; calculating heart rate variability (HRV) data for the members of the audience at the venue in correlation with the stimuli; performing statistical analysis on the HRV data of the members of the audience; and determining emotions of the members of the audience.

Another aspect of the present disclosure provides a method comprising: presenting media content to members of an audience at a venue; collecting heart rate data of individual members of the audience using one or more infrared sensors at the venue; determining a variation in heart rate signals of each member of the audience and correlating the variation with parts of the media content, wherein the part of the media content is one or more of a beginning of the media content or change in beat, rhythm or tempo of the media content; calculating heart rate variability (HRV) data for the members of the audience at the venue in a correlation of parts of the media content; capturing sudden movements of the audience above a certain threshold in correlation with the media content; and determining, using the HRV data and sudden movements of the audience, the engagement of the audience with the media content being played.

Another aspect of the present disclosure provides a method for recommending media content, comprising: continuously collecting HRV data for an audience at a venue using one or more IR sensors; determining engagement of the audience by analyzing the collected HRV data over a specified time period; detecting turnover in audience's population by a pre-determined threshold; and recommending replaying the entire playlist based on one or more of the turnover event, venue location and time of day.

Another aspect of the present disclosure provides a method comprising: presenting media content to members of an audience at a venue; collecting heart rate data of individual members of the audience using one or more infrared sensors at the venue; determining a variation in heart rate signals of each member of the audience and correlating the variation with parts of the media content, wherein the part of the media content is one or more of a beginning of the media content or change in beat, rhythm or tempo of the media content; calculating heart rate variability (HRV) data for the members of the audience at the venue in a correlation of parts of the media content; capturing visual data of the audience; determining the gender of individual audience members based on the captured visual data using AI-based image recognition algorithms; and recommending a next media content or generating a media content playlist based on identified gender majority and HRV data.

What is claimed is:

1. A method of determining engagement of an audience with media content being played at a venue or event, the method comprising:
collecting gesture data of individual members of the audience, wherein the gesture data comprises one or more or head movement data, body movement data and facial expression data;
correlating individual gesture data with parts of media content being played;
measuring an engagement level of a member of the audience using an AI model trained to measure engagement based on one or more of gesture data, characteristics of media content, time of day information, event information and venue information;
determining one or more of an aggregate engagement level of the audience, a number of members of the audience engaged with the media content and proportion of members of the audience engaged with the media content.

2. The method according to claim 1, wherein the part of the media content is one or more of a beginning of the media content or change in beat, rhythm or tempo of the media content.

3. The method according to claim 1, wherein the gesture data is determined from images captured by one or more cameras at the venue.

4. The method according to claim 3, wherein the method includes determining areas of overlap in field of views of the one or more cameras and removing duplicate measurements due to the overlapping fields of view.

5. The method according to claim 1, wherein the method includes creating a new media content playlist based on the determined engagement level, number of engaged members of the audience and/or proportion of engaged members of the audience.

6. The method according to claim 1, wherein the method includes updating a media content playlist based on the determined engagement level, number of engaged members of the audience and/or proportion of engaged members of the audience.

7. A method of determining engagement of an audience with media content being played at a venue or event, the method comprising:
collecting physiological data of individual members of the audience, wherein the physiological data comprises one or more or heart rate data, breathing rate data and temperature data;
correlating individual physiological data with parts of media content being played; and
determining one or more of an aggregate engagement level of the audience, a number of members of the audience engaged with the media content and proportion of members of the audience engaged with the media content.

8. The method according to claim 7, wherein the method includes determining changes in physiological data and correlating changes in physiological data with parts of the media content.

9. The method according to claim 7, wherein the part of the media content is one or more of a beginning of the media content or change in beat, rhythm or tempo of the media content.

10. The method according to claim 7, wherein the physiological data is determined from images captured by one or more infrared sensors at the venue.

11. The method according to claim 7, wherein the method includes determining areas of overlap in field of views of the one or more infrared sensors and removing duplicate measurements due to the overlapping fields of view.

12. The method according to claim 7, wherein the method includes measuring an engagement level of a member of the audience using an Al model trained to measure engagement based on one or more of physiological data, characteristics of media content, time of day information, event information and venue information.

13. The method according to claim 7, wherein the method includes creating a new media content playlist based on the determined engagement level, number of engaged members of the audience and/or proportion of engaged members of the audience.

14. The method according to claim 7, wherein the method includes updating a media content playlist based on the determined engagement level, number of engaged members of the audience and/or proportion of engaged members of the audience.

15. A method for selecting media content to be played at a venue or event, the method comprising:
determining an engagement level of persons present at the event or venue with media content being played at the event or venue;
adapting a media content playlist based on the determined engagement level in real time.

16. The method according to claim 15, wherein the engagement level is an aggregate engagement level for the persons at the event or venue.

17. The method according to claim 15, wherein the engagement level is an individual engagement level for a person at the event or venue.

18. The method according to claim 15, wherein the engagement level is determined by correlating parts of media content being played with one or more of gesture data and physiological data of the persons at the venue or event.

19. The method according to claim 18, wherein the gesture data is determined from images obtained from one or more cameras at the event or venue.

20. The method according to claim 18, wherein the physiological data is determined from measurements obtained from one or more infrared sensors at the event or venue.

21. A method comprising:
capturing gaze data of a customer looking at an item in a store using a camera;
collecting heart rate variability (HRV) data of the customer using an infrared (IR) camera simultaneously;
calculating a time period for the customer looking at the said item;
correlating the collected HRV data with the captured gaze data for the time the customer looking at the said item;
generating an interest score based on the HRV data, the gaze data, and the time the customer spends looking at the said item; and
determining a level of interest of the customer in the said items at the store.
